(19) United States
(12) Patent Application Publication
(10) Pub. No.: US 2007/0051032 A1
(43) Pub. Date: Mar. 8, 2007

(54) Storage Device for Hook-Less Flies

(76) Inventor: Patrick E. Moffitt, Califon, NJ (US)

Correspondence Address: DIEHL SERVILLA LLC, 77 BRANT AVE, SUITE 110, CLARK, NJ, 07066, US

(21) Appl. No.: 11/468,116

(22) Filed: Aug. 29, 2006

Related U.S. Application Data
(60) Provisional application No. 60/713,989, filed on Sep. 2, 2005.

(51) Int. Cl. A01K 97/06

(52) U.S. Cl. 43/54.1; 43/57.1

(57) ABSTRACT

A fly storage device for a hook-less fly and method for storing the same is disclosed. The device includes an attachment loop and a storage means for receiving the eye of the hook-less fly. It can also include a handle. A plurality of storage means can be provided. A storage box having means to receive one or more of the attachment loops can also be provided.

### STATEMENT OF RELATED CASES

This patent application claims the benefit of and priority to U.S. Provisional Patent Application No. 60/713,989, filed Sep. 2, 2006.

### BACKGROUND OF THE INVENTION

Artificial fishing flies of current design are constructed on steel hooks. Artificial flies, as a consequence, are stored in boxes to protect the hooks from rusting and prevent the hooks from fouling with clothing or other objects. Hook-less artificial flies, however, are tied on a core that does not rust and cannot foul with clothing. Current hook storage devices are therefore not practical for use with hook-less flies.

A means is therefore necessary to store hook-less flies such that an angler can forego the need for cumbersome and heavy boxes.

### SUMMARY OF THE INVENTION

A fly storage device for a hook-less fly is described. In accordance with one aspect of the invention, the storage device includes an attachment loop and storage means for receiving the eye of the hook-less fly. It can also include a handle. One or more flies can be attached to the storage device, and a plurality of storage means can be provided. Various storage means are disclosed herein.

In accordance with a further aspect of the present invention, a storage box can be provided. The storage box includes means to receive one or more of the attachment loops. For example, the storage box can include a clip that can receive one or more of the attachment loops. As another example, the storage box can include a slit that can receive one or more of the attachment loops. The slit can be provided in foam inside the storage box.

The storage means can be made of any material, including but not limited to metal, spring wire, plastic or plastic coated wire.

The fly storage device can also include a stop device. In accordance with a further aspect of the present invention, the fly storage device includes a distal attachment loop, a second loop section and a terminal non-loop section. It can also include a handle and there can be a plurality of structures to which a fly can be attached. These structures can extend from the attachment loop or from the handle.

### DESCRIPTION OF THE DRAWINGS

FIG. 1 shows a hook-less fly storage tool in accordance with one aspect of the present invention.

FIG. 2 shows a threader loop in accordance with another aspect of the present invention.

FIG. 3 shows an alternate embodiment of a threader loop in accordance with a further aspect of the present invention.

FIG. 4 demonstrates further aspects of the present invention in relation to the device of FIG. 2.

FIG. 5 shows a threader device in accordance with another aspect of the present invention.

FIG. 6 shows a threader loop in accordance with another aspect of the present invention.

FIG. 7 shows a cut-away view of a fly box with a foam insert in accordance with a further aspect of the present invention.

FIGS. 8 and 9 illustrate a threader loop in accordance with various aspects of the present invention.

### DESCRIPTION OF A PREFERRED EMBODIMENT

Hook-less artificial flies are tied on a non-metallic core terminating in a resilient attachment eye allowing the fly to be loop-connected to a fishing line. A hook-less fly cannot rust or snag clothing, and as such can be carried on an angler's exterior clothing. Artificial flies stored on clothing in this manner afford ease of access and reduced weight.

Hook-less artificial flies can be connected to a fishing line by passing a loop of line through a threader device which has previously passed through the eye of a hook-less fly. The fly and the loop of line are pulled from the threader leaving the loop of fishing line through the hook-less fly's attachment eye. The loop of line is next passed over the body of the fly and pulled taut fixing the fly in place on the line. Storing hook-less flies on a threader in accordance with the present invention, is therefore a practical and convenient practice.

In one embodiment of the present invention, wire or monofilament is folded forming a threader loop. Two or more separate threader loops are created in this way and bound together at the open ends. The loops can be bound by thread, glue, welding or any other suitable process. Material forming the threader loops may be metal or plastic in composition. The bound ends are next inserted into a handle and affixed thereto. The distal end of the handle terminates in a structure capable of attaching to a clip or string. The various threader loops protruding from the handle may be of different colors allowing the angler to quickly identify the correct loop containing a desired fly. The threader loops may also be made in varying lengths as appropriate for the fly size or number stored. The handle can be composed of any suitable material including plastics and wood.

Hook-less flies are stored on the threader loop by inserting the tip of the loop through the eye of the hook-less fly and pushing the fly up the threader. The flies remain on the threader, until needed, by the friction of the hook-less fly's eye structure, by the size of the threader's expanding mid-section being larger than the diameter of the hook-less fly's eye or the fly's eye expanding when pushed over a large diameter stop device and once rebounding being too small to pass back over the stop device.

In a further embodiment of the present invention, a threader loop is formed terminating in an attachment structure most often an eye-like form on the distal end. The threader can be formed by wire bending, molding, soldering or gluing, connection tube or wrapping the loop sections into the appropriate form. Multiple such threader loops can be attached by threading each attachment eye onto a device capable of being affixed to clothing.

In a further embodiment of the present invention, a length of wire or plastic, preferably with a diameter less than the eye of a hook-less fly, terminates in a small threader loop. The distal end of the wire or plastic is a tube like-device or clip capable of connecting to the terminal threader loop creating a closed circle. A smaller ring is threaded onto the device to allow attachment to clothing or other location. Hook-less flies are threaded over the loop and onto the thin diameter wire or plastic. In a preferred embodiment the flies can be easily moved around the circular device, when closed, allowing access to a particular fly mounted on the device.

In a further embodiment a section of plastic coated wire is fused together by the application of heat to form the threader loop. The attachment eye can be similarly formed or created by other methods such as crimping or adhesives. The threader assembly may have a single wire strand on the forward end which facilitates threading through the hook-less fly's elastic eye. A second single wire strand or non-looped section may also be provided and located between the threader loop and the assembly's attachment eye. An additional high friction coating may be added to prevent flies from easily slipping off the device.

Some anglers may prefer to organize hook-less flies in boxes. A threader loop can be connected to a structure capable of fitting into a foam slit common to many conventional fly boxes. This structure may take a variety of shapes applicable to fitting into a fly box's foam slit that has been designed to previously hold the point and bend of a conventional fly's hook. The threader section of this hook-less fly holder may or may not terminate in a non-loop section and is affixed at its terminal end to a plastic device capable of being easily held and efficiently secured by the foam slits within the fly storage box.

The various aspects of the present invention will be discussed further with respect to the drawings.

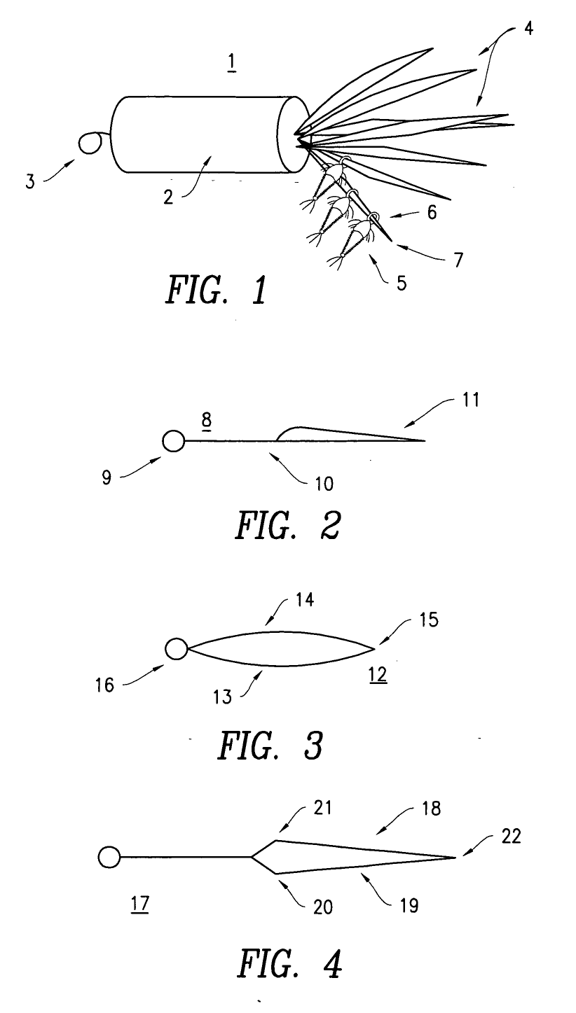

FIG. 1 shows a hook-less fly storage tool 1 consisting of a handle 2 with an attachment eye 3 and various threader loops 4. A hook-less fly 5 is stored by threading an eye 6 of the hook-less fly 5 over a tip 7 of a threader loop 4. A number of flies can be stored on each threader loop.

The tip 7 of the storage device receives the eyes of the flies. In accordance with one aspect of the present invention, the eyes are flexible so they expand around a wider section of the threader loop 4 located near the middle of the threader loop 4 and then contract once the eye 6 is past the middle. In accordance with another aspect of the present invention, the middle section of the threader loop 4 can be flexible so that it can become narrower as the eye 6 is slid over it.

FIG. 2 shows a threader loop 8 terminating in an attachment eye 9. A leg 10 connects the loop 11 to the attachment eye 9. A eye can be slid over the tip past the loop section 11 and thus be stored.

FIG. 3 shows an alternate embodiment of a threader loop 12 whereby the two legs 13 and 14 forming the loop 15 are connected directly to an attachment eye or clip 16. An eye of a fly would slide over the two legs 13 and 14 and be retained near the attachment eye or clip 16. Again, the eye can flex around the legs 13 or 14 or the legs 13 and 14 can be flexible to accommodate the eye.

FIG. 4 demonstrates the legs 18 and 19 of the loop can take various positions and angles 20 and 21 with respect to FIG. 2. The tip of the threader loop 22 should be small enough to easily accept the eye of a hook-less fly.

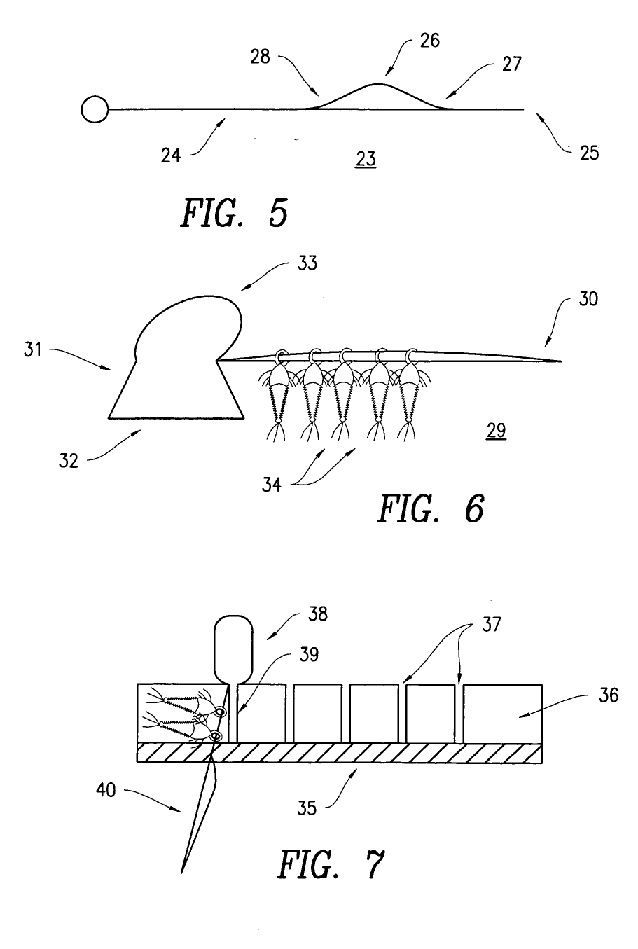

FIG. 5 shows a threader device 23 with a main leg 24 terminating in a point 25 capable of being easily inserted into the eye of a hook-less fly. A loop 26 is formed at a distance from the point 25 and attached at locations 27 and 28. The material to form the loop 26 can be made of a separate material and may have characteristics such as diameter and rigidity different from the main leg 24. A plastic threader loop can be molded with these characteristics eliminating the need for separate attachment points as shown 27 and 28.

FIG. 6 shows a threader loop 29 capable of being inserted into a fly box's foam slit used for storing conventional hooked flies. A loop 30 is attached to a structure 31 with its ventral surface 32 shape adapted for insertion into a fly box's hook holding slit. The dorsal design 33 of structure 31 allows the threader loop to be easily held and maneuvered by hand. The width of the ventral surface 32 of structure 31 must fit the width of the fly box foam holding device. The length of the loop 30 can vary as a function of the size and number of hook-less flies 34 desired for attachment.

FIG. 7 shows a cut-away view of a fly box 35 with a foam insert 36. The foam 36 has a plurality of slits 37 capable of accepting a hook or a threader loop 38. Threader loop 38 is as described in FIG. 6 and rotated 90 degrees to the front. The ventral section 39 of the threader loop 38 fits securely in the provided foam slit 37. The loop section 40 can be oriented such that its long axis is either parallel or orthogonal to the foam slits 37.

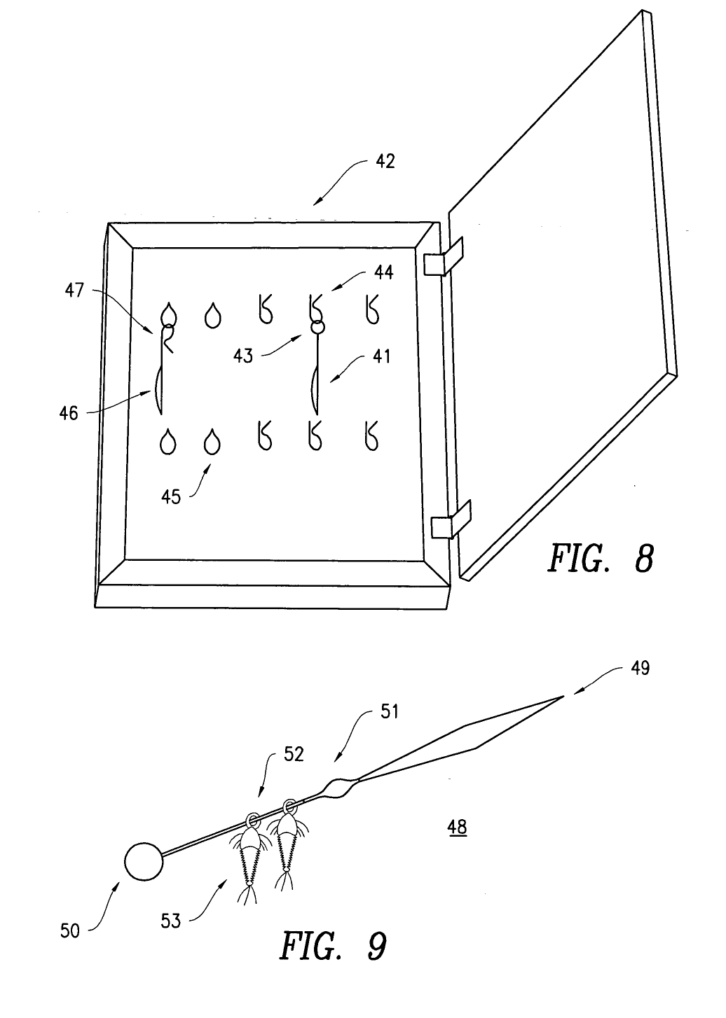

FIG. 8 shows a threader loop 41 that can be stored in a fly box 42 and held by fixing a threader loop's attachment eye 43 to a clip 44 fastened to the bottom of the fly box 42. The fly box 42 may additionally be configured with eye attachment structures 45 and the threader loop 46 terminating in a clip 47.

FIG. 9 shows a threader loop 48 with a forward loop 49, a distal eye or clip 50 and a stop device 51. The stop device 51 is not limited by materials of construction and as such may be glued, molded, tied or slip-fitted in place. The stop device 51 should have a diameter slightly larger than the relaxed eye 52 of a hook-less fly 53. The shape of the stop device should assist in expanding the rubber-like eye 52 of a hook-less fly when adding to or removing from the loop 49. The rubber-like eye 52 of a hook-less fly 53 initially expands to pass over the stop device 51 then rebounds to its resting size which being smaller than the stop device 51 prevents a hook-less fly 53 from being easily dislodged and lost.

Various storage means have been disclosed in each of the figures. Each of the storage means can be constructed of metal, spring wire, plastic, plastic coated wire or similar material.

While there have been shown, described and pointed out fundamental novel features of the invention as applied to preferred embodiments thereof, it will be understood that various omissions and substitutions and changes in the form and details of the device illustrated and in its operation may be made by those skilled in the art without departing from the spirit of the invention. It is the intention, therefore, to be limited only as indicated by the scope of the claims appended hereto.

1. A fly storage device for a hook-less fly, the hook-less fly having an eye, comprising:
an attachment loop; and
storage means for receiving the eye of the hook-less fly.

2. The fly storage device of claim 1, comprising a handle.

3. The fly storage device of claim 1, comprising one or more hook-less flies attached to the storage means.

4. The fly storage device of claim 1, comprising a plurality of storage means.

5. The fly storage device of claim 1, comprising a storage box, the storage box having means to receive one or more of the attachment loops.

6. The fly storage device of claim 1, comprising a storage box, the storage box having a clip that can receive one or more of the attachment loops.

7. The fly storage device of claim 1, comprising a storage box, the storage box having a slit that can receive one or more of the attachment loops.

8. The fly storage device of claim 1, wherein the storage means is metal.

9. The fly storage device of claim 1, wherein the storage means is spring wire.

10. The fly storage device of claim 1, wherein the storage means is plastic.

11. The fly storage device of claim 1, wherein the storage means is plastic coated wire.

12. The fly storage device of claim 1, comprising a stop device.

13. A fly storage device for one or more hook-less flies, comprising:
a distal attachment loop;
a second loop section; and
a terminal non-loop section.

14. The fly storage device of claim 13, comprising a handle.

15. The fly storage device of claim 14, comprising a plurality of structures claimed in claim 13 extending from the handle.

16. The fly storage device of claim 13, comprising a storage box, the storage box having means to receive one or more of the attachment loops.

17. The fly storage device of claim 13, comprising a storage box, the storage box having a clip that can receive one or more of the attachment loops.

18. The fly storage device of claim 13, comprising a storage box, the storage box having a slit that can receive one or more of the attachment loops.

19. The fly storage device of claim 13, comprising a stop device.

20. The fly storage device of claim 19, wherein the stop device is located on the second loop section.
